(19) United States
(12) Patent Application Publication
(10) Pub. No.: US 2013/0051590 A1
(43) Pub. Date: Feb. 28, 2013

(54) Hearing Enhancement and Protective Device

(71) Applicant: Patrick Slater, Austin, TX (US)

(72) Inventor: Patrick Slater, Austin, TX (US)

(21) Appl. No.: 13/601,784

(22) Filed: Aug. 31, 2012

Related U.S. Application Data
(60) Provisional application No. 61/529,506, filed on Aug. 31, 2011.

(51) Int. Cl. H04R 25/00

(52) U.S. Cl. 381/317

(57) ABSTRACT

A hearing aid is provided which includes (a) a receiver section equipped with a receiver; (b) a lateral section equipped with a microphone and a battery; (c) a sealing retainer concentrically positioned over said receiver section which conforms to the walls at the bony region of the ear canal, thereby seating the hearing device in the ear canal and providing acoustical sealing against feedback within the ear canal; and (d) a circuit which dampens or suppresses at least a portion of the acoustical footprint of a threshold event, or which deactivates the hearing aid for a time interval in response to a threshold event.

### CROSS-REFERENCE TO RELATED INVENTION

This application claims the benefit of U.S. provisional application No. 61/529,506, filed Aug. 31, 2011, having the same title and the same inventor, and which is incorporated herein by reference in its entirety.

### TECHNICAL FIELD OF THE INVENTION

The present disclosure pertains generally to hearing aids, and more particularly to a hearing aid designed for use by hearing impaired individuals who wish to engage in hunting or the use of firearms.

### BACKGROUND OF THE INVENTION

According to recent data compiled by the National Institute on Deafness and Other Communication Disorders (NIDCD), approximately 17 percent (36 million) of American adults report some degree of hearing loss. Hearing loss adversely affects the daily activities and experiences of those afflicted.

Hearing loss is especially burdensome to individuals who enjoy hunting. The sounds of wildlife add to the enjoyment of the hunting experience. Moreover, an experienced hunter is often able to detect the presence and location of prey through audio cues, such as the sound of movement in the underbrush or the whirring of wings, before the prey becomes visible. Since the time frame in which a hunter has a clear shot at his prey is often quite short, such audio cues are frequently the difference between success or failure.

A variety of hearing aids have been developed which are designed to augment the hearing of the user. Most of these devices operate by amplifying portions of the audio spectrum so that the user experiences something akin to normal hearing. However, many of these devices are unsuitable for use by hunters, military police, and other users who must contend with noisy environments. In particular, many hearing aids indiscriminately amplify noises across a portion of the spectrum, and thus amplify sounds, such as muzzle reports, which may be unpleasant or damaging to the user.

Some attempts have been made in the art to address this issue. For example, U.S. Pat. No. 4,315,111 (Thomas) discloses a hearing aid which is said to be specifically adapted for hunting. The hearing aid is equipped with a switch which may be disposed in a shoulder pad worn by a hunter. The pressure exerted on the pad by a rifle butt purportedly activates the switch so that the hearing aid is turned off shortly before the gun is fired. Hence, the device amplifies sounds of interest to the hunter without also amplifying the muzzle blast. However, the approach described in Thomas relies on pressure activation which is prone to error and which is difficult to implement in practice. Consequently, this approach may result in failure to deactivate the hearing aid when a gun is fired. Moreover, the device is prone to being triggered by incidental contact with the user's shoulder.

Another device which is purportedly directed to this problem is marketed under the trade name Walker's Game Ear™. This device, which is currently sold in some hunting supply stores, purportedly increases hearing by as much as 11 times. According to the associated literature, this device includes “a Sound Activated Compression circuit that when combined with the ear plug design protects hearing from loud sounds such as muzzle blasts.” According to an article appearing in the January 2001 issue of Guns Magazine, “Walker's Game Ear amplifies sounds while its tuned-circuitry cuts off the destructive sound of gunfire, making it ideal for hunting and target shooting”.

### SUMMARY OF THE INVENTION

In one aspect, a hearing aid is provided which includes (a) a receiver section equipped with a receiver; (b) a lateral section equipped with a microphone and a battery; (c) a sealing retainer concentrically positioned over said receiver section which conforms to the walls at the bony region of the ear canal, thereby seating the hearing device in the ear canal and providing acoustical sealing against feedback within the ear canal; and (d) a circuit which dampens or suppresses at least a portion of the acoustical footprint of a threshold event, or which deactivates the hearing aid for a time interval in response to a threshold event. The threshold event may be, for example, the discharge of a firearm. The disposition of the sealing retainer at the bony region of the ear canal greatly improves the comfort experienced by a person wearing the device, since occlusive effects are avoided. Consequently, the wearer is unaware of the presence of the device.

In another aspect, a method is provided for operating a hearing augmentation device. The method includes providing a hearing aid which includes (a) a receiver section equipped with a receiver; (b) a lateral section equipped with a microphone and a battery; and (c) a sealing retainer. The sealing retainer is concentrically positioned over the receiver section such that the sealing retainer conforms to the walls at the bony region of the ear canal, thereby seating the hearing augmentation device in the ear canal and providing acoustical sealing against feedback within the ear canal. In response to a threshold event, at least a portion of the acoustical footprint of the threshold event is dampened or suppressed, or the hearing augmentation deice is deactivated for a time interval. The disposition of the sealing retainer at the bony region of the ear canal greatly improves the comfort experienced by a person wearing the hearing augmentation device, since occlusive effects are avoided. Consequently, the wearer is unaware of the presence of the device.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 is a side view of the ear canal.

FIG. 2 is a cross-sectional view of the cartilaginous region of the ear canal.

FIG. 3 is a side view of the ear canal with an embodiment of the hearing aid disclosed herein completely inserted within it and showing the non-occlusive lateral (free floating) and occlusive medial boney section.

FIG. 4 is a detailed view of the non-occluding lateral portion canal device embodiment of FIG. 3, showing a lateral section, including cylindrically elongated battery assembly and microphone section, which is flexibly connected to the receiver section with a sealing retainer concentrically positioned around it, thus occluding the medial boney canal portion.

FIG. 5 is an exploded view of the canal device embodiment of FIGS. 3 and 4 showing the core assembly, battery assembly and sealing retainer in a disassembled state.

FIG. 6 is a cross-sectional view of the lateral section of the hearing aid as inserted into the ear canal, illustrating the substantial air-space clearance and minimal contact with the walls of the lateral ear canal.

FIG. 7 is a view of a typical button-cell battery showing the diameter (D) and length (L) dimensions.

FIG. 8 is an illustration of a noise suppression circuit which may be utilized in embodiments of the hearing aid described herein.

FIG. 9 is a graph of time-domain waveforms recorded at locations of a shooter's right and left ear during the discharge of a .22 caliber Hornet Winchester Model 43.

FIG. 10 is a graph of gunshot waveforms, taken at an on-axis position, for 10 different firearms.

### DETAILED DESCRIPTION OF THE INVENTION

While the Walker's Game Ear™ device may overcome some of the infirmities of the device disclosed in U.S. Pat. No. 4,315,111 (Thomas), it suffers from some infirmities of its own. In particular, this device is an inexpensive amplification device which does not produce the audio fidelity provided by a higher quality hearing aid device. Consequently, this device does not impart the experience of normal hearing to the user. Moreover, this device is an external amplification device which sits on the earlobe, and which is equipped with a tube connecting the device electronics to an ear plug that is inserted into the lateral cartilaginous ear canal. Consequently, this device is conspicuous, and its use—especially over longer durations—causes discomfort and occlusive effects. Moreover, incidental contact with the device during use can dislodge the device or damage the ear of the user.

There is thus a need in the art for a hearing aid or other hearing augmentation device which provides high audio fidelity to the user, and which is amenable to use by hunters or other users that must contend with noisy environments. There is further a need in the art for such a device which is inconspicuous during use. There is also a need in the art for such a device which is comfortable to wear over longer durations, and which avoids occlusive effects. These and other needs may be met by the devices and methodologies disclosed herein.

It has now been discovered that the foregoing needs may be met through the provision of a hearing aid which may be positioned entirely within the lateral ear canal in a minimally occluding fashion. This disposition of the device allows it to be employed in extended use without requiring daily removal from the ear canal, and also eliminates problems with incidental contact associated with externally disposed devices. The hearing aid is equipped with circuitry or other means adapted to temporarily deactivate the device or to provide an acoustical dampening effect or noise suppression when a threshold event occurs. Such a threshold event may be, for example, the potentially harmful portion of an acoustical footprint associated with a noise such as a firearm report, or other damaging noises which extend over, or exceed, a preset decibel level, sound pressure and/or frequency range. Consequently, the user can enjoy the high audio fidelity associated with a quality, full-time hearing aid, without experiencing injury or discomfort during use of a firearm or through exposure to other damaging noises associated with the occupation or environment of the user.

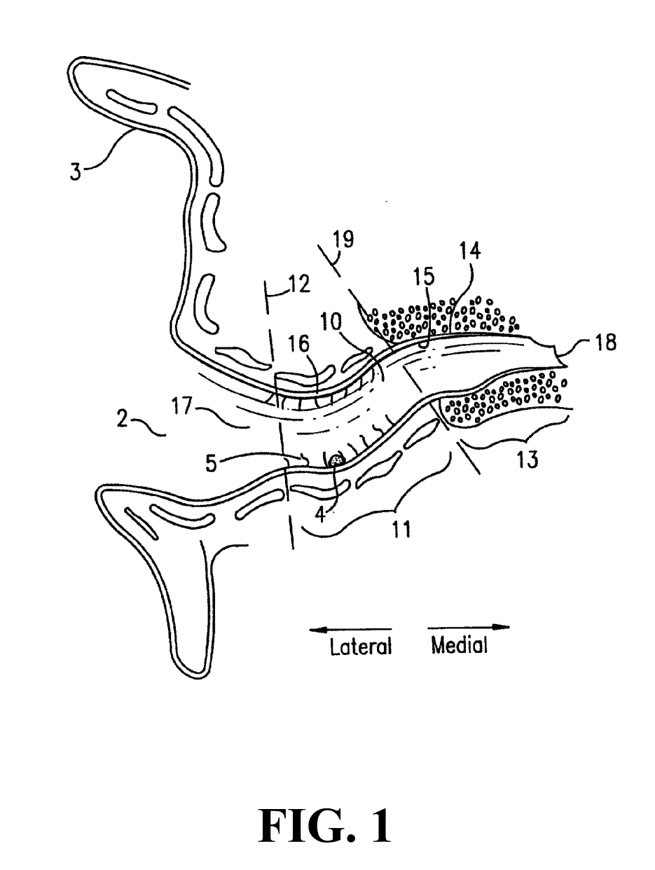

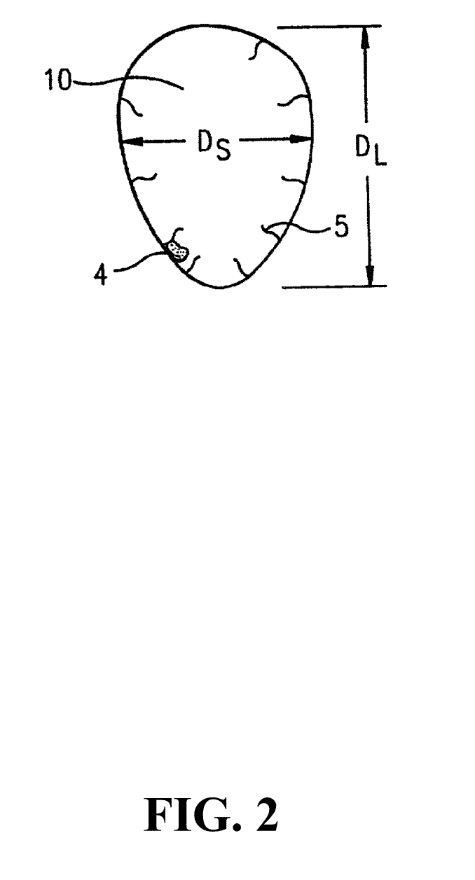

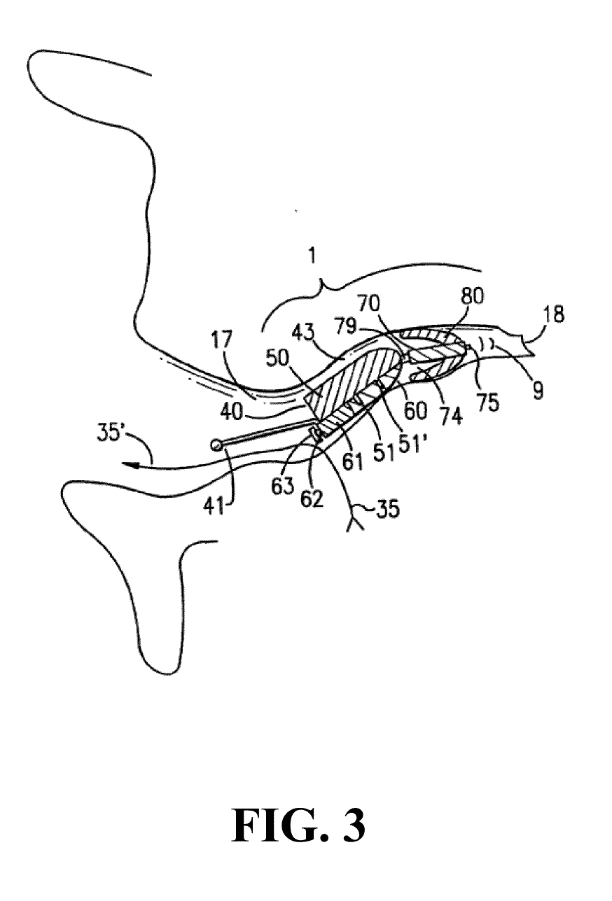

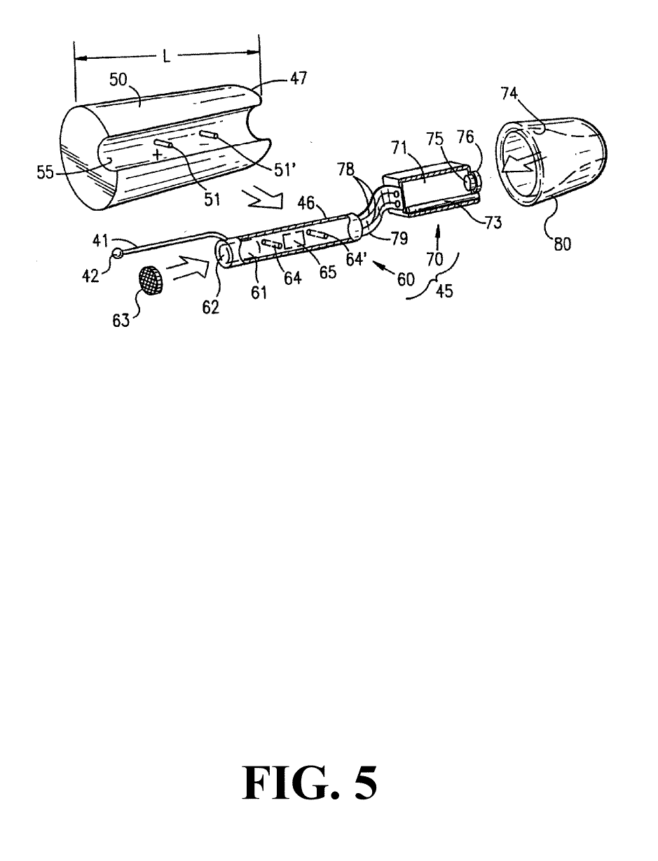

FIGS. 3-5 depict a first particular, non-limiting embodiment of a hearing aid 1 made in accordance with the teachings herein (by way of reference, FIGS. 1-2 illustrate the internal details of the human ear canal to illustrate how the hearing aid 1 is disposed therein). As seen in FIGS. 3-5, the hearing aid 1 (see FIG. 3) comprises a core assembly 45 (see FIG. 5) which contains a microphone section 60 and a receiver section 70. The microphone section 60 is configured so that it may be readily positioned laterally (see FIG. 3) in the cartilaginous region 11 (see FIG. 1) of the ear. Similarly, the receiver section 70 is adapted to be positioned medially (see FIG. 3) in the bony region 13 (see FIG. 1) of the ear canal. As seen in FIG. 3, the hearing aid 1 also comprises a battery assembly 50 which is removably connected to the microphone section 60. The battery assembly 50 and the microphone section 60 form a lateral section 40 when combined.

When the hearing aid 1 is inserted into position within the ear canal 10 (see FIG. 1), the lateral section 40 (see FIG. 3) is essentially suspended in the cartilaginous region 11 (see FIG. 1) in a non-occluding fashion, and with only incidental contact (that is, minimum or no contact) with the walls of the ear canal.

With the hearing aid positioned as described above, the receiver section 70 (see FIG. 3) is secured to the bony part of the ear canal by way of a conforming sealing retainer 80, which is concentrically positioned around or over the receiver section 70. The sealing retainer 80 acoustically seals the canal at the bony region, thus preventing acoustic feedback while securing the core assembly 45 and the attached battery assembly 50. The sealing retainer 80 is preferably adapted to comfortably conform to the walls of the ear canal in the bony region where it is to be seated, thus facilitating insertion and retention of the hearing device 10 within the canal. This disposition also gives the attenuation effect necessary for hearing protection.

The receiver section 70 is preferably physically and electrically connected to the microphone section 60 by way of a flexible connection 79. The flexible connection 79 facilitates insertion of the hearing aid 1 by allowing the device to be bent while it is being positioned within the ear canal, particularly during insertion through the second bend at the bony junction 19 (see FIG. 1). The receiver section 70 (see FIG. 3) contains a receiver 71 (transducer) with a receiver sound port 75 for emitting sounds 9 towards the tympanic membrane 18, with which it is preferably in close proximity to.

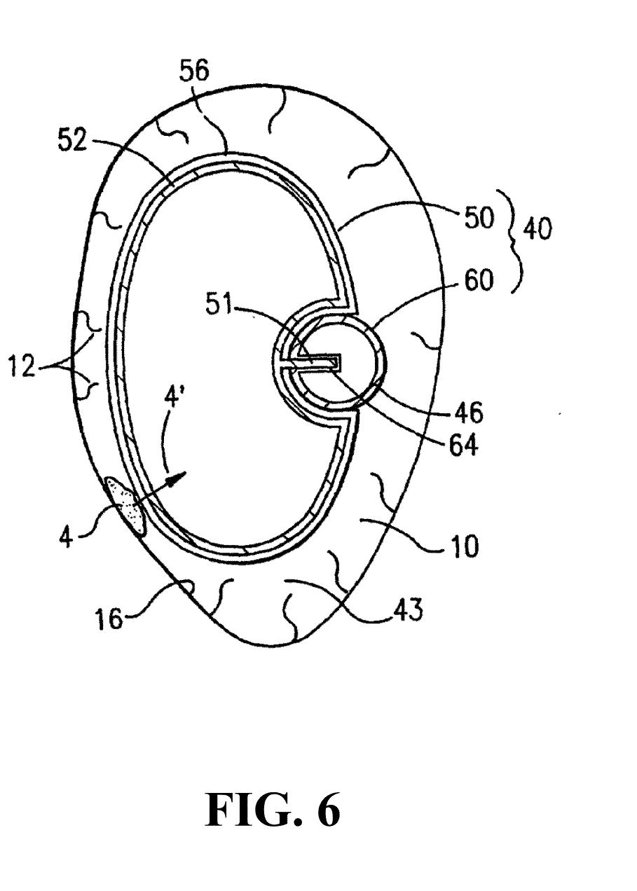

As seen in FIG. 6, the battery assembly 50 in the hearing aid 1 has a generally oval cross sectional perimeter. The oval perimeter has long diameter D_{L} and short diameter D_{S}, corresponding to the long and short diameters, respectively, of the typical ear canal 10. The battery assembly 50 is preferably generally cylindrically elongated along the longitudinal axis of the hearing aid 1; this longitudinal axis corresponds to the longitudinal axis of the ear canal when the hearing aid 1 is inserted into position in the canal, as shown in FIG. 3. Preferably, the length L (see FIG. 5) is greater than the long diameter D_{L} (see FIG. 2) of the oval cross-section.

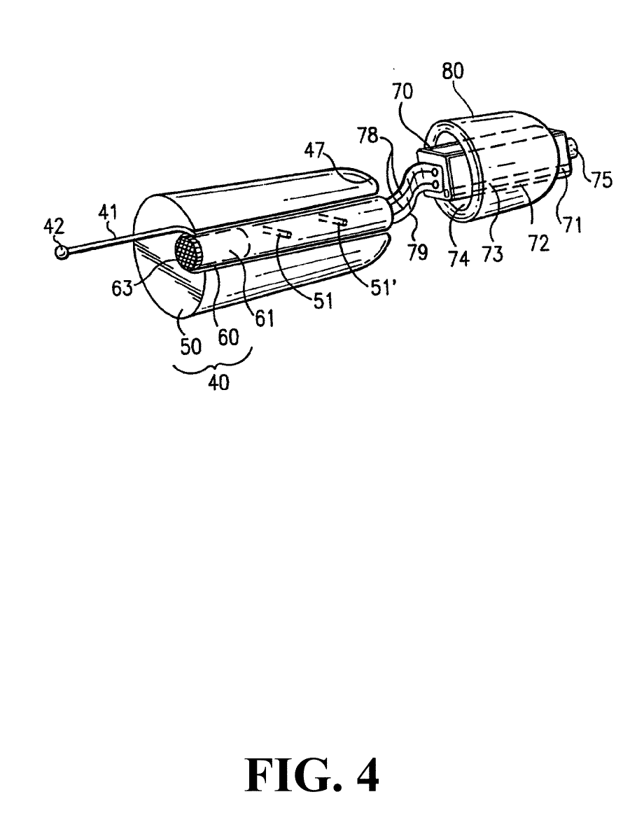

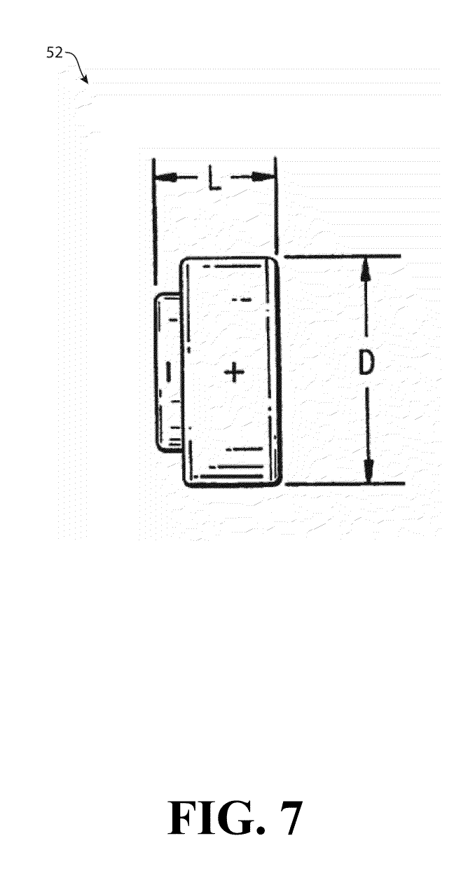

The hearing aid 1 disclosed herein differs in some notable respects from many of the hearing aids currently known to the art. For example, the cylindrically elongated shape of the battery assembly 50 (see FIG. 4) differs from conventional button-cell hearing aid batteries. Moreover, in many hearing aids, conventional batteries are designed for placement within a separate battery compartment and within a unitary plastic housing, and thus do not make direct contact with the environment of the ear canal. By contrast, the battery assembly 50 of the hearing aid 1 disclosed herein preferably comprises its own thin biocompatible enclosure 56 (see FIG. 6) within the battery assembly 50. This enclosure may be disposed of along with the battery 52 (see FIG. 7) when the battery power is depleted.

The battery assembly 50 in a preferred embodiment of the hearing aids made in accordance with the teachings herein comprises a battery 52 within enclosure 56, having a sectional void 55 (see FIG. 5) for accommodating (receiving) microphone section 60. When the battery assembly and the microphone section 60 are so combined by being mated together, the resultant lateral section 40 (see FIG. 6) has a shape which is preferably primarily that of the removable battery assembly 50, and is thus also preferably cylindrically elongated and of generally oval cross-sectional perimeter.

The removable attachment of the battery assembly 50 to the microphone section 60 of the core assembly 45 (see FIG. 5) is preferably through one or more protruding electrical contacts (e.g., connector pins). For example, FIG. 4 shows a positive connector pin 51 and a negative connector pin 51′ which are insertable in microphone section 60 via pin receptacles 64 and 64′ (see FIG. 5), respectively. The insertable pin connection is a preferred method for providing reliable and space-efficient electrical and mechanical connectivity between the battery assembly 50 and the core assembly 45 (see FIG. 5). The sectional void (recess) 55 may be of any appropriate shape to accommodate the battery section 60 of the core assembly 45.

Regardless of the mating configuration between the battery assembly and the microphone section, the outer surface of the formed lateral section 40 (see FIG. 4) is primarily that of the battery section comprising at least 60% of the combined surface area. A sealant or a gasket, composed of an appropriate sealing material, is preferably provided at interface area between the battery assembly 50 and the microphone section 60 for protecting the contacts which provide electrical communication between these components.

The microphone section 60 comprises a microphone 61 (transducer) having a sound port 62 (see FIG. 5) for receiving unamplified sounds entering the ear canal 10 (see FIG. 1). The microphone section 60 (see FIG. 5) may also comprise signal processing amplifier 65 and other components commonly used in hearing aids. Microphone port 62 is protected by a debris guard 63 which is made by an acoustically transparent and moisture-proof material. The debris guard 63 protects the sensitive diaphragm (not shown) within the microphone 63 from the damaging effects of moisture, cerumen and other debris entering the ear canal. The receiver sound port 75 may also be protected by a receiver debris guard 76. Debris accumulation eventually renders debris guards ineffective. Therefore, in the preferred embodiments of the invention, the debris guards, 63 and 76, are replaceable for periodic disposal thereof as necessary.

FIG. 6 shows a cross-sectional view of the ear canal with lateral section 40 positioned in the cartilaginous region 11 (see FIG. 1) in a substantially non-occluding fashion. As illustrated in FIG. 6, a substantial clearance 43 (air-space) exists between the perimeter of the lateral section 40 and the interior walls 16 of the ear canal in this region. This minimizes interference with hair 12 and cerumen (earwax) 4 which may be present in the cartilaginous part of the ear canal 10 as shown. Since the lateral section 40 is flexibly connected to the relatively immobile receiver section 70 (see FIG. 5) in the bony part via flexible connection 79, the lateral section is allowed to move within the ear canal in response to canal deformations during jaw movements, or in response to cerumen accumulation.

FIG. 6 shows, for example, cerumen 4 between the lateral section 40 and a wall 16 of the ear canal. Cerumen accumulation pushes the movable lateral section 40 in the direction of arrow 4′ as shown. The clearance 43 also minimizes the acoustic occlusion effect by diverting occlusion sounds (35 and 35′) (see FIG. 3) away from the tympanic membrane 18 (protected by the sealing retainer 80) towards the outside of the ear canal.

The minimal contact of the non-occluding lateral section 40 also allows for natural production and lateral migration of cerumen and other debris in the cartilaginous region 11. The receiver section 70, in contrast, occludes the ear canal in the bony region 13 via the associated sealing retainer 80 as shown in FIG. 3.

The core assembly 45 (see FIG. 5) and battery assembly 50 each have individual thin encapsulations 46 and 56 (see FIG. 6), respectively. The encapsulations 46 and 56 preferably comprise a moisture-proof material or coating such as silicone, parylene or acrylic. The thin encapsulation may be made soft such as soft silicone or rigid such as hard acrylic.

The enclosure at the flexible connector 79 (see FIG. 5) preferably comprises a flexible material. The microphone section 60 (see FIG. 6) may comprise a rigid substrate, or potting, protective of internal components within. Since the hearing device of the invention is handled relatively infrequently owing to its extended wear capability, the thickness of any encapsulation can be safely substantially thinner than conventional enclosures of CIC devices, which are typically in the range of 0.5-0.7 mm. The core assembly encapsulation 46 and battery encapsulation 56 are preferably less than 0.3 mm. in thickness, and even much thinner for the battery assembly since it is removable and disposable in the preferred embodiments. The thin battery encapsulation 56 is preferably constructed so that it substantially conforms to the shape of the battery, thus adding negligible dimensions to the enclosed battery.

Various deactivation and acoustical dampening and/or suppression devices or algorithms may be employed in the hearing aids described herein to protect the user from potentially harmful noises. These devices or algorithms may have associated with them various parameters (including, but not limited to, frequency, time, and sound pressure), and various thresholds or ranges for these parameters, which control when and how these devices or algorithms operate. For example, these devices or algorithms may be configured to deactivate the hearing aid for a predetermined interval of time when a threshold event occurs, and may be further configured to employ any necessary or desirable acoustical suppression or dampening when the time interval has elapsed.

For these purposes, a threshold event may be defined as an event in which the threshold value for one or more of these parameters is exceeded. The threshold values for these parameters may be defined in conjunction with, or independently of, each other. In some embodiments, threshold values for multiple parameters must be exceeded in order for the event to constitute a threshold event.

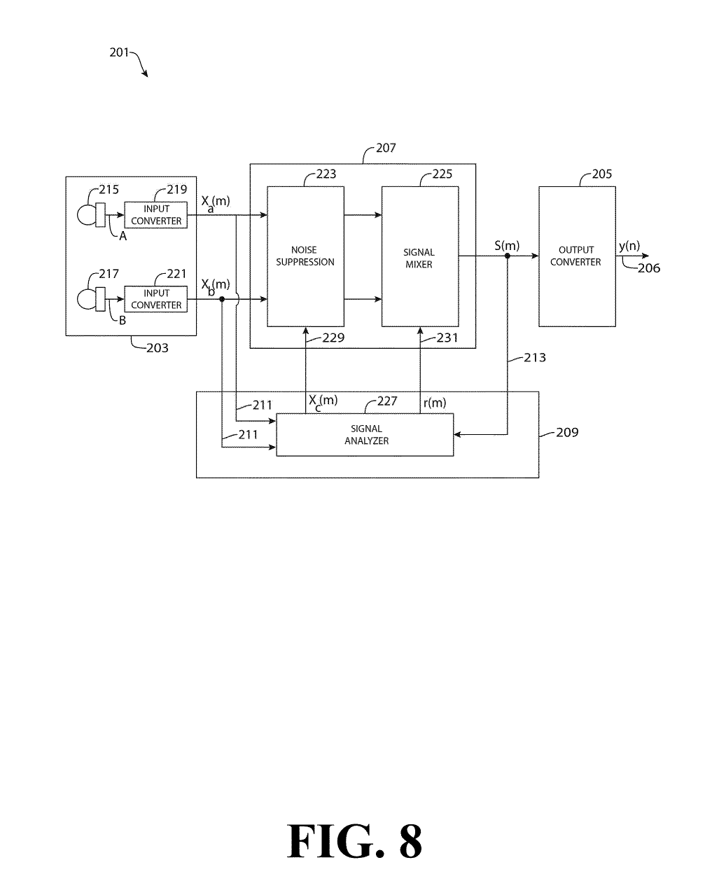

FIG. 8 depicts a particular, non-limiting embodiment of an adaptive noise suppression system (ANSS) 201 which may be utilized in the hearing aids described herein. The data flow through the ANSS 201 flows through an input converting stage 203 and an output converting stage 205. Between the input stage 203 and the output stage 205 is a filtering stage 207 and an analyzing stage 209. The analyzing stage 209 includes a feed-forward path 211 and a feedback path 213.

Analog signals A(n) and B(n) are first received in the input stage 203 at receivers 215 and 217, which are preferably microphones. These analog signals A and B are then converted to digital signals Xₙ(m)(n=a, b) in input converters 219 and 221. After this conversion, the digital signals Xₙ(m) are fed to the filtering stage 207 and the feed-forward path 211 of the analyzing stage 209. The filtering stage 207 also receives control signals H_{c}(m) and r(m) from the analyzing stage 209, which are used to process the digital signals Xₙ(m).

In the filtering stage 207, the digital signals Xₙ(m) are passed through a noise suppressor 223 and a signal mixer 225, and generate output digital signals S(m). Subsequently, the output digital signals S(m) from the filtering stage 207 are coupled to the output converter 205 and the feedback path 213. Digital signals Xₙ(m)and S(m) transmitted through paths 211 and 213 are received by a signal analyzer 227, which processes the digital signals Xₙ(m)and S(m) and outputs control signals H_{c}(m) and r(m) to the filtering stage 207. Preferably, the control signals include a filtering coefficient H_{c}(m) on path 229 and a signal-to-noise ratio value r(m) on path 231. The filtering stage 207 utilizes the filtering coefficient H_{c}(m) to suppress noise components (such as those associated with a firearm report) of the digital input signals. The analyzing stage 209 and the filtering stage 207 may be implemented utilizing either a software-programmable digital signal processor (DSP), or a programmable/hardwired logic device, or any other combination of hardware and software sufficient to carry out the described functionality.

In some embodiments, the hearing aids described herein may be configured to provide protection to the user for harmful noises in general, or for broad ranges of harmful noises as measured by various parameters. For example, in some embodiments, the hearing aid may be adapted to suppress or dampen any noise that is at least 85 dB, at least 100 dB, at least 110 dB or at least 120 dB sound pressure level (SPL), or to enter a deactivation state for a period of time when such noises are detected. Here, it is to be noted that the peak sound pressure level (SPL) occurring at a shooter's ear depends on the firearm in question, and has been measured to range from 132 dB (for a miniature rifle) to 183 dB (for a howitzer). By comparison, with extended exposure, noises that reach a decibel level of 85 or greater can cause permanent damage to the microscopic hair cells found inside the cochlea, thus leading to hearing loss.

In embodiments in which the hearing aid is adapted to deactivate for a period of time when a threshold event is detected, the duration of deactivation may vary. For example, the duration of deactivation may be up to 5 ms, but is typically within the range of 0.25 ms to 5 ms, preferably within the range of 1 ms to 4 ms, more preferably within the range of 1.5 ms to 3 ms, even more preferably within the range of 2 ms to 3 ms, and most preferably within the range of 2.5 ms to 3 ms.

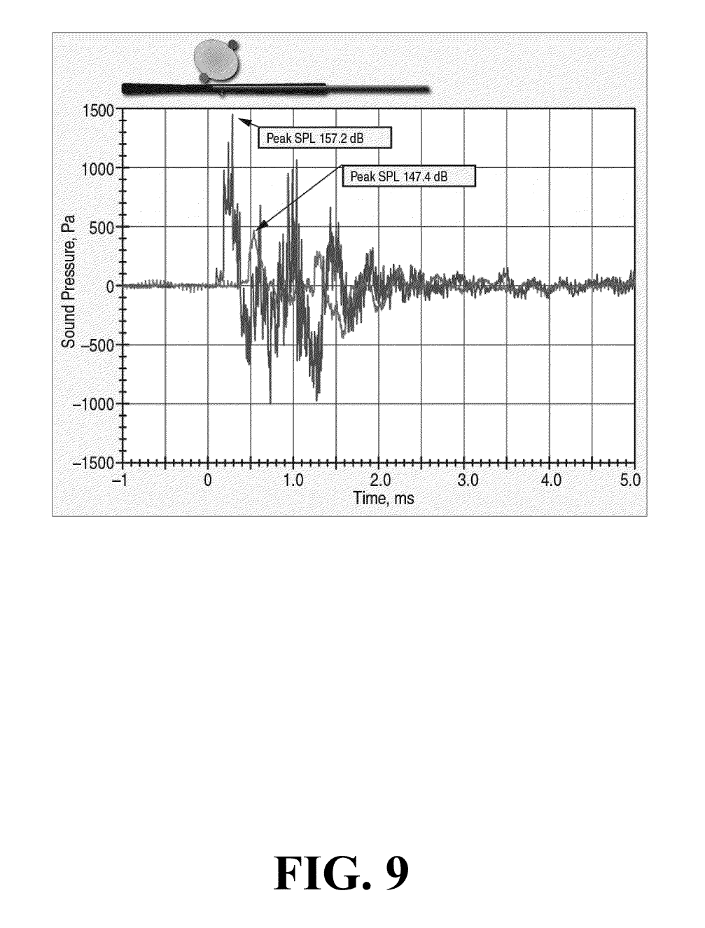

The advantages of the foregoing deactivation time periods and threshold levels may be appreciated with respect to FIG. 9, which is a graph of time-domain waveforms recorded at locations of a shooter's right and left ear during the discharge of a .22 caliber Hornet Winchester Model 43 (see Rasmussen et al., “Measuring Recreational Firearm Noise”, Sound & Vibration, pp. 14-18 (August 2009)). As seen therein, the waveforms differ for the right and left ear, with the left ear actually being subject to earlier and more pronounced sound pressure. Without wishing to be bound by theory, the greater pressure experienced at the left ear is believed to be due to diffraction around the shooter's head and closer proximity to the muzzle, while the reduced pressure experienced at the right ear is believed to be due to head shadowing effects which reduce the blast wave. Consequently, even though the right ear is physically closer to the stock of the firearm, the left ear is exposed to higher sound pressure levels.

As further seen in FIG. 9, the peak sound pressure experienced at the left ear (for the subject firearm) is about 157 dB, while the peak sound pressure experienced at the left ear is about 147 dB. Moreover, although the sound pressure wave peaks for the left and right ears are asynchronous, both follow a decaying wave function, with the sound pressure experienced at both ears diminishing significantly within 2 ms of discharge. Hence, a hearing aid which deactivates for 2 ms from the time at which a threshold event (e.g., the sound pressure wave associated with a firearm discharge) is detected eliminates the need to suppress or dampen the highest pressure waves associated with the discharge. While harmful sound pressures may persist beyond this range, this portion of the acoustical footprint of the threshold event may be more readily dealt with by noise suppression or dampening algorithms implemented by the hearing aid.

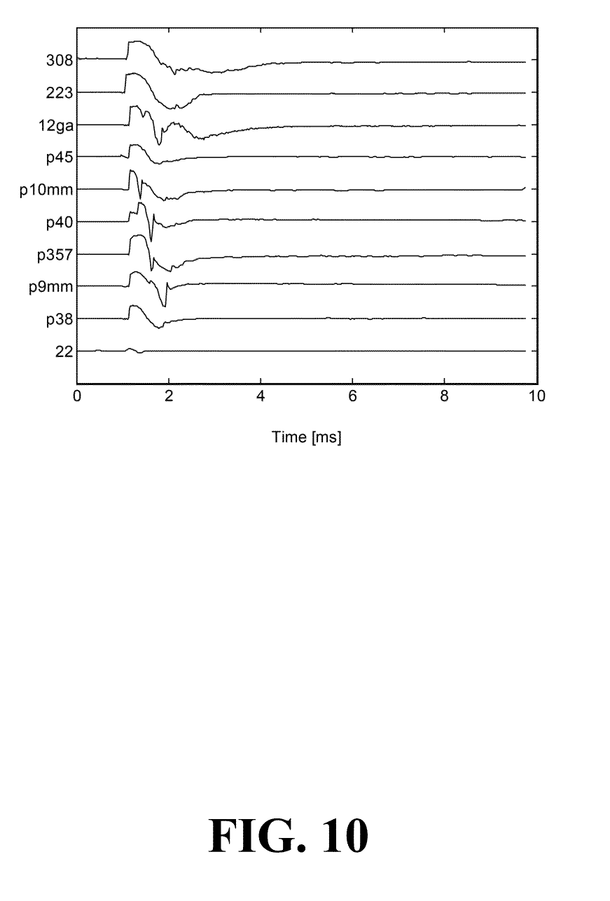

The advantages of the foregoing deactivation time periods and threshold levels may be further appreciated with respect to FIG. 10, which is a graph of gunshot waveforms (taken at an on-axis position) for 10 different firearms (see Maher et al., “Directional Aspects of Forensic Gunshot Recordings”, AES 39th International Conference, Hillerød, Denmark, pp. 1-6 (Jun. 17-19, 2010). The firearms, which provide a representative cross-section of commonly available firearms, include a 308 Winchester rifle (“308”), a 223 Remington rifle (“223”), a Remington 870 12 gauge shotgun (“12 ga”), a 45 ACP handgun (“p45”), a Glock 20 10 mm auto handgun (“p10 mm”), a 40 Smith & Wesson handgun (“P40”), a 357 Magnum handgun (“P357”), a Glock 19 9×19 mm handgun (“p9 mm”), a 38 Special handgun (“p38”), and a CZ-452 22 long rifle (“22”). Although the amplitude and shape of the waveform for each firearm is found to vary as a function of the angle to the on-axis for the point at which the data is collected, the duration of the higher amplitude portion of the waveform is found to remain essentially the same. As seen from FIG. 10, this duration is less than about 2 ms for all of the subject firearms. Hence, hearing aids of the type described herein may be configured to deactivate for a time interval of about 2 ms following the onset of a threshold event, thus effectively eliminating the high amplitude portion of the acoustical footprint of most common firearms.

The devices or algorithms which provide hearing aid deactivation, acoustical dampening and/or suppression in the hearing aids described herein may also be responsive to frequency, especially those associated with the discharge of a firearm. Thus, for example, a threshold event may be characterized, in part or in whole, as an event having a frequency within the range of about 10 Hz to about 3000 Hz, preferably within the range of about 15 Hz to about 2500 Hz, more preferably within the range of about 15 Hz to about 2000 Hz, and most preferably within the range of about 10 Hz to about 1500 Hz. Here, it is to be noted that the spectral content of the main part of the acoustic energy associated with commonly available firearms has been found to be less than 400 Hz (peak 16-100 Hz) for large-caliber weapons, and 150-2,500 Hz (peak 900-1,500 Hz) for small-caliber weapons (such as rifles).

In some embodiments, the hearing aid may be programmable by the user, a physician or a technician over a device equipped with a user interface, and preferably a graphical user interface (GUI). By way of example, the hearing aid may be programmable wirelessly through the use of software resident on a computing device (such as a PC) or a mobile communications device or platform. Such programming may be utilized, for example, to tailor or optimize the noise suppression or dampening characteristics of the hearing aid, or the hearing aid deactivation settings, to a firearm that the user of the hearing aid regularly uses or is exposed to. In such embodiments, the software may be adapted to capture the acoustical footprint of the firearm, either through the software host device or through the hearing aid, and may use the acoustical footprint to program the hearing aid for the purposes noted above. The software may also be adapted to download the acoustical footprint for the firearm for similar purposes from a website. This website may be associated, for example, with the firearm manufacturer or a firearm distributor or retailer, or may be associated with the hearing aid manufacturer.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A hearing aid, comprising:
a receiver section equipped with a receiver;
a lateral section equipped with a microphone and a battery;
a sealing retainer which is concentrically positioned over said receiver section such that the sealing retainer conforms to the walls at the bony region of the ear canal, thereby seating the hearing aid in the ear canal and providing acoustical sealing against feedback within the ear canal; and
a circuit which dampens or suppresses at least a portion of the acoustical footprint of a threshold event, or which deactivates the hearing aid for a time interval in response to a threshold event.

2. The hearing aid of claim 1, wherein said threshold event is the discharge of a firearm.

3. The hearing aid of claim 1, wherein said circuit deactivates the hearing aid for a time interval in response to the threshold event; and wherein said time interval is within the range of 2 ms to 3 ms.

4-8. (canceled)

9. The hearing aid of claim 3, wherein said threshold event is defined as a noise having an associated sound pressure of at least 85 dB.

10-11. (canceled)

12. The hearing aid of claim 1, wherein said lateral section is essentially oval in cross-section and is essentially cylindrical and elongated shape along its longitudinal axis.

13. The hearing aid of claim 1, wherein said lateral section provides at least partial lateral suspension in the ear canal without occlusion thereof when said hearing aid is inserted within the ear canal.

14. (canceled)

15. The hearing aid of claim 1, wherein said lateral section is medially tapered.

16. The hearing aid of claim 1, wherein said lateral section is dimensioned for said non-occlusion with essentially no contact with the walls of the ear canal when said hearing device is inserted therein.

17. The hearing aid of claim 1, wherein said lateral section further comprises a stabilizer for positioning between the outer surface of said lateral section and the walls of the ear canal to center and stabilize said lateral section within the ear canal when said device is inserted therein.

18. The hearing aid of claim 1, wherein said receiver section and lateral section are disposed in a core assembly, wherein said core assembly is equipped with a moisture-proof encapsulation, and wherein the outer surface of the encapsulation is at least partially exposed to the environment of the ear canal when said device is inserted therein.

19. The hearing aid of claim 1, wherein said receiver section is flexibly connected to said lateral section to facilitate insertion of said core assembly within the ear canal, and to allow movement of said lateral section in response to canal movements or to accumulation of debris within the ear canal.

20. The hearing aid of claim 1, further comprising at least one acoustically-transparent, moisture-proof debris guard which protects a sound port of at least one of said microphone and said receiver.

21. The hearing aid of claim 1, further comprising an air vent for pressure equalization.

22. The hearing aid of claim 1, wherein said microphone includes an amplifier integral therewith for processing acoustic signal.

23. The hearing aid of claim 1, further including programming means for selectively adjusting electro acoustic parameters of said hearing device.

24. The hearing aid of claim 1, further including remote control means for controlling at least one control parameter of said hearing device.

25. The hearing aid of claim 22, wherein said remote control means includes means operative using at least one of sound, ultrasound, magnetic, electromagnetic, radio frequency and infrared signals.

26. The hearing aid of claim 1, wherein said sealing retainer has an oval cross-sectional perimeter.

27. The hearing aid of claim 1, wherein said sealing retainer comprises a compressible material.

28. The hearing aid of claim 17, wherein said compressible material responds to compression by undergoing time-delayed expansion to assume a sealing fit within the ear canal when the hearing device is inserted therein.

29. The hearing aid of claim 1, wherein said sealing retainer comprises a conforming material.

30. The hearing aid of claim 29, wherein said sealing retainer comprises a silicone or polyurethane foam.

31. The hearing aid of claim 1, wherein said sealing retainer is configured to form an air-gap relative to said receiver section when fitted thereon.

32. The hearing aid of claim 1, wherein said sealing retainer is removable from said hearing device and disposable for replacement thereof.

33-35. (canceled)

36. The hearing aid of claim 1, wherein said oval cross-sectional perimeter of said lateral section has a long diameter to short diameter ratio of approximately 1.4.

37. A method is provided for operating a hearing augmentation device, comprising:
providing a hearing augmentation device which includes (a) a receiver section equipped with a receiver; (b) a lateral section equipped with a microphone and a battery; and (c) a sealing retainer;
concentrically positioning the sealing retainer over the receiver section such that the sealing retainer conforms to the walls at the bony region of the ear canal, thereby seating the hearing augmentation device in the ear canal and providing acoustical sealing against feedback within the ear canal; and
in response to a threshold event, either (i) dampening or suppressing at least a portion of the acoustical footprint of the threshold event, or (ii) deactivating the hearing augmentation device for a time interval.

38. The method of claim 37, wherein said threshold event is the discharge of a firearm.

39. The method of claim 37, comprising deactivating the hearing augmentation device for a time interval in response to the threshold event.

40-42. (canceled)

43. The method of claim 39, wherein said time interval is within the range of 1.5 ms to 3 ms.

44. (canceled)

45. The method of claim 39, wherein said threshold event is defined as a noise having an associated sound pressure of at least 85 dB.

46-47. (canceled)
